(19) United States
(12) Patent Application Publication
(10) Pub. No.: US 2003/0234054 A1
(43) Pub. Date: Dec. 25, 2003

(54) Electromagnetic valve

(76) Inventors: Shigeki Niimi, Kariya-shi (JP); Atsushi Furusawa, Toyota-shi (JP)

Correspondence Address: REED SMITH LLP, Suite 1400, 3110 Fairview Park Drive, Falls Church, VA, 22042, US

(21) Appl. No.: 10/421,833

(22) Filed: Apr. 24, 2003

(30) Foreign Application Priority Data
Apr. 24, 2002 (JP) 2002-122751

(51) Int. Cl. F15B 13/044

(52) U.S. Cl. 137/625.65

(57) ABSTRACT

An electromagnetic valve includes a plunger driven by an electromagnetic mechanism, a tubular spool moved by the plunger in the axial direction, a valve body having fluid passages, a sleeve accommodating the spool therein so as to be able to slide in the axial direction and fitted into the valve body, a ball member pressed into one end of the spool and a pushing member fixed to the plunger and contacted with the ball member.

The present application is based on and claims priority under 35 U.S.C § 119 with respect to Japanese Patent application No. 2002-122751 filed on Apr. 24, 2002, the entire content of which is incorporated herein by reference.

### FIELD OF THE INVENTION

The present Invention relates to an electromagnetic valve.

### BACKGROUND OF THE INVENTION

A conventional electromagnetic valve of this kind is disclosed, for example, in Japanese laid-open Publications No. 10-122404 or No. 11-166641. This valve includes a plunger driven by an electromagnetic mechanism, a spool moved by the plunger in the axial direction, a valve body in which fluid passages are formed and a sleeve in which the spool is accommodated and which is fitted into the valve body. In the electromagnetic valve disclosed in the former publication, a pushing member is pressed into the plunger and is contacted with a spherical portion which is formed on one end of the spool. Thereby, the spool is moved in the axial direction of the valve body in response to the movement of the plunger. On the other hand, in the electromagnetic valve disclosed in the latter publication, a spherical portion is formed on one end of a pushing member which is pressed into the plunger and is contacted with one end of the spool so that the spool is moved in the axial direction of the valve body. In these valves, the declination and the inclination of the axial centers of the pushing member and the spool is absorbed by the spherical portion.

In the above valves, however, since it is necessary to form the spherical portion on one end of the pushing member or one end of the spool by process, the manufacturing cost of the valve is increased. Further, since it is necessary to form the pushing member and the spool by a material having superior wear resistance and impact-resistance, the manufacturing cost of the valve is further increased.

### SUMMARY OF THE INVENTION

It is, therefore, a principal object of the present invention to provide an improved electromagnetic valve which overcomes the above drawbacks.

In order to attain the foregoing object, the present invention provides an electromagnetic valve which includes a plunger driven by an electromagnetic mechanism, a tubular spool moved by the plunger in the axial direction, a valve body having fluid passages, a sleeve accommodating the spool therein so as to be able to slide in the axial direction and fitted into the valve body, a ball member pressed into one end of the spool and a pushing member fixed to the plunger and contacted with the ball member.

### BRIEF DESCRIPTION OF THE DRAWINGS

The above object, features and advantages of the present invention will be more apparent and more readily appreciated from the following detailed description of a preferred exemplary embodiment of the present invention, taken in connection with the accompanying drawing, in which;

FIG. 1 is a cross sectional view of an electromagnetic valve according to an embodiment of the present invention.

### DETAILED DESCRIPTION OF THE PRESENT INVENTION

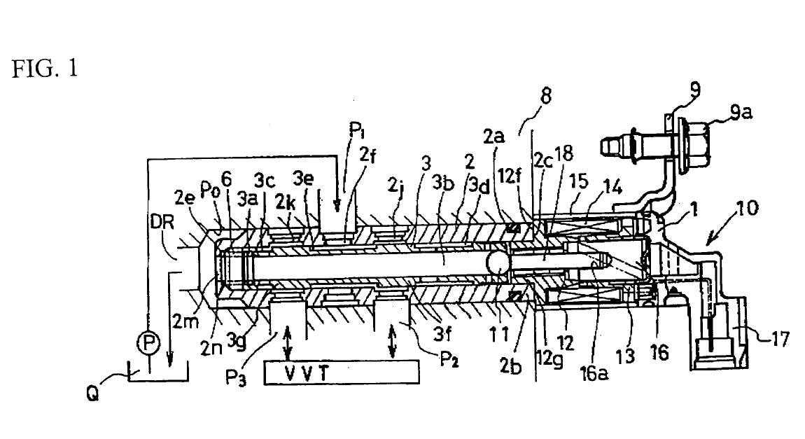

Referring to FIG. 1, an electromagnetic valve 10 is a linear type electromagnetic valve and is used to control the pressure or the flow rate of the fluid which is used for controlling a subject of the control such as, for example, a variable valve timing control device (VVT) or a vehicular automatic transmission and so on.

The electromagnetic valve 10 includes an electromagnetic mechanism 1 which is controlled by duty signal from electric control unit (not shown), a spool 3 which is moved by the electromagnetic mechanism 1 and a cylindrical sleeve 2 in which the spool 3 is disposed so as to be able to slide in the axial direction. The electromagnetic valve 10 is fitted into a hole Po which is formed on a cylinder block 8 of an engine and is fixed to the cylinder block by a screw 9a through a bracket 4. The cylinder block 8 corresponds to a valve body of the present invention.

Fluid pressure from a fluid pressure source P Is supplied to the electromagnetic valve 10 through a fluid passage P1 of the cylinder block 8. Further, the electromagnetic valve 10 supplied the fluid pressure to the VVT through fluid passages P2, P3 formed on the cylinder block 8 and discharges the fluid pressure to an oil pan Q through a fluid passage DR.

The electromagnetic mechanism 1 includes a front yoke member 12 which has an approximately cylindrical shape and which is made of magnetic material, a rear yoke member 13 which has an approximately cylindrical shape and which is made of magnetic material, a cylindrical bobbin which is made of resin, a coil 14 which is wound on the bobbin, a case 15 which is made of magnetic material, a plunger 16 which is made of magnetic material and which is movable in the axial direction by electromagnetic force, a connector 17 and so on.

A cylindrical concave portion 16a is formed on one end of the plunger 16 and a pushing member 18 is pressed into the concave portion 16a. The case 15 is snugly fitted on the outer circumference of the front yoke 12. Thereby, it is prevented that water comes in the electromagnetic mechanism 1 from outside. Further, it is prevented that the fluid leaks from inside of the electromagnetic mechanism 1.

The electromagnetic mechanism 1 is pressed into the right end 2b of the sleeve 2 through a projecting portion 12g of the front yoke 12. Thereby, the end surface 2c of the right end 2b of the sleeve 2 is contacted with a stepped portion 12f of the front yoke 12. As a result, it is prevented that water comes in the electromagnetic mechanism 1 from outside. Further, it is prevented that the fluid leaks from inside of the electromagnetic mechanism 1.

The spool 3 has an approximately cylindrical shape. A penetrating passage 3b which is used as a drain passage is formed in the spool 3. Further, radial passages 3c, 3d are formed so as to communicate between the penetrating passage 3b and the outer circumference of the spool 3. A circular grooves 3e is formed on the outer circumference of the spool 3. A ball member 11 is pressed into an opening of the penetrating passage 3b of one end side of the spool 3 which is opposite to the electromagnetic mechanism 1 and is always contacted with one end of the pushing member 18. The ball member 11 is a ball of all-purpose ball bearing and has superior wear resistance and impact-resistance.

The inner diameter of the penetrating passage 3b is constant in the axial direction and is the same as the inner diameter of the opening thereof into which the ball member 11 is pressed. The inner diameter of the opening thereof into which the ball member 11 is pressed may be larger than the inner diameter of the penetrating passage 3b. Thereby, it is able to form the penetrating passage 3b without changing the inner diameter in the axial direction and therefore tubular material can be used to the spool 3. Further, it is not necessary to form the spool 3 by material having superior wear resistance and impact-resistance. Accordingly, the manufacturing cost of the electromagnetic valve can be reduced.

A spring 6 is interposed between the sleeve 2 and the spool 3. One end of the spring 6 contacts with a stepped portion 2e of the sleeve 2 and the other end of the spring 6 contacts with a stepped portion 3a of the spool 3. Thereby, the spool 3 is always urged toward the electromagnetic mechanism 1 and the ball member 11 is always contacted with the pushing member 18.

First radial port 2f are formed on the sleeve 2 so as to penetrate in the radial direction. Second radial ports 2j and third radial ports 2k are formed on the sleeve 2 so as to penetrate in the radial direction, respectively. The second and third radial ports 2j, 2k are located at both side of the first radial ports 2f in the axial direction of the sleeve 2. Further, a fourth port 2n is formed on the left end of the sleeve 2 so as to open in the axial direction. An outer circular groove 2a is formed on the outer circumference of the sleeve 2 and a seal ring is fitted in the groove 2a.

When the electromagnetic valve is not operated, the spool 3 is urged toward the electromagnetic mechanism 1 by the spring 6 and the spool 3 is in the condition shown in FIG. 1. Therefore, the fluid passage P1 is communicated to fluid passage P2 through the first radial ports 2f, the circular groove 3e and the radial second ports 2j. Thereby, the fluid pressure from the fluid pressure source P is supplied to VVT. Further, the fluid returned from the VVT is discharged to the oil pan Q through the fluid passage P3, the third radial ports 2k, the radial passage 3c, the penetrating passage 3b, the forth port 2m and the drain passage DR.

When the duty signal is supplied to the electromagnetic mechanism 1 and the electromagnetic valve 10 is operated, the plunger 16 is moved toward the spool 3 by the magnetic force. Then, the pushing member 18 pushes the spool 3 through the ball member 11 and the spool 3 Is moved leftward against the urging force of the spring 6. When the spool 3 is moved leftward, the rand portions 3f, 3g close the second radial ports 2j and the third radial ports 2k, respectively and the fluid supply to VVT is interrupted.

When the duty ratio of the duty signal supplied to the electromagnetic mechanism 1 is further increased, the spool 3 contacts with the left end portion 2e of the sleeve 2 and the movement of the spool 3 stops. At this time, the communication between the fluid passage P1 and the second radial ports 2i is interrupted and the communication between the fluid passage P1 and the fluid passage P3 through the circular groove 3e and the second radial ports 2k is established. Thereby, the fluid pressure from the fluid pressure source P is supplied to VVT. Further, the fluid returned from the VVT is discharged to the oil pan Q through the fluid passage P2, the radial passage 3d, the penetrating passage 3b, the fourth radial ports 2m and the drain passage DR.

The invention has thus been shown and described with reference to a specific embodiment, however, it should be understood that the invention is in no way limited to the details of the illustrates structures but changes and modifications may be made without departing from the scope of the appended claims.

What is claimed is:

1. A an electromagnetic valve comprising:
a plunger driven by an electromagnetic mechanism,
cylindrical spool moved by the plunger in the axial direction,
a valve body having fluid passages,
a sleeve accommodating the spool therein so as to be able to slide in the axial direction and fitted into the valve body,
a ball member pressed into one end of the spool and
a pushing member fixed to the plunger and contacted with the ball member.

2. An electromagnetic valve as set force in claim 1, wherein the spool has a penetrating passage penetrating in the axial direction and the ball member is pressed into an opening of one end of the penetrating passage.

3. An electromagnetic valve as set force in claim 2, wherein the inner diameter of penetrating passage is the same as the inner diameter of the opening or is smaller than the inner diameter of the opening.
